(19) United States
(12) Patent Application Publication
(10) Pub. No.: US 2009/0234896 A1
(43) Pub. Date: Sep. 17, 2009

(54) REMOTE COPY METHOD AND STORAGE SYSTEM

(75) Inventor: Shinichi Takaoka, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/403,980

(22) Filed: Mar. 13, 2009

(30) Foreign Application Priority Data
Mar. 17, 2008 (JP) 2008-067477

(51) Int. Cl. G06F 17/30

(52) U.S. Cl. 707/204; 707/E17.01

(57) ABSTRACT

A remote copy method is executed in a storage system having a plurality of storage devices each comprising a recording medium for recording data on a file-by-file basis and a computer for controlling the recording medium. The plurality of storage devices are connected to each other via a network. Data within the recording medium contained in a source storage device are remote-copied to the recording medium within a destination storage device on a volume-by-volume basis or a block-by-block basis. The computer executes: an accepting procedure of accepting transmission file information for identifying a file that is to be a transmission target among a plurality of files stored in a source recording medium; and a storage procedure of storing the transmission file information accepted by the accepting procedure into the source recording medium.

### CROSS-REFERENCE TO RELATED APPLICATION

This application is based upon and claims the benefit of priority from the prior Japanese Patent Application No. 2008-67477, filed on Mar. 17, 2008, the entire contents of which are incorporated herein by reference.

### FIELD

The present invention relates to methods and systems for remote copying of data among a plurality of storage devices.

### BACKGROUND

Remote copy function is a technique for copying data from one storage device to another storage device in a storage system comprising a plurality of storage devices connected at a distance via a network. Business data such as form data, client data, management data, mail data, and support service data (such as update program data and patch program data) may be stored in a plurality of storage devices by this remote copy function. If one of the storage devices fails because of a disaster, continuation of business is possible using the business data reserved in another storage device.

This remote copy function is realized by installing dedicated software into computers of a plurality of storage devices. Data transmission side (source) software retrieves data from a recording medium in a source storage device at a predetermined time and transmits the data to data reception side (destination) software. Upon receiving the data, the data reception side (destination) software updates the data in a recording medium contained in a destination storage device.

In a storage system in which the above-described remote copy function is implemented, when the user of a source storage device stores a desired file in a recording medium within the storage device, the file is copied automatically into a recording medium within a destination storage device by the remote copy function. Therefore, if the user of the destination storage device can retrieve the just-mentioned file from the recording medium contained in the destination storage device, the storage system in which the conventional remote copy function is implemented can be used not only as a system for backing up business data but also as a file transmission system.

The above-described software that implements the remote copy, however, is configured to copy the data within the recording medium only volume by volume or block by block. Therefore, it is possible that the user of the destination device may not be able to identify which of the plurality of files copied to the destination storage device is the one designated as the transmission target by the user of the source device, although the transmission target file is copied (or transmitted) to the recording medium within the destination storage device by the remote copy once it is stored in the recording medium within the source storage device.

The present invention has been accomplished in view of the problems that arise when the conventional storage system in which the remote copy function is implemented is used also as a file transmission system. It is an object of the invention to make it possible to identify which of the files that are stored in a recording medium of a source storage device and also copied to a recording medium of a destination storage device by remote copy is the file designated as a transmission target by the user of the source.

### SUMMARY

A remote copy method devised in order to solve the foregoing problem is a remote copy method executed in a storage system comprising a plurality of storage devices each comprising a recording medium for recording data on a file-by-file basis and a computer for controlling the recording medium. The plurality of storage devices are connected to each other via a network. Data within the recording medium contained in a source storage device are remote-copied to the recording medium within a destination storage device on a volume-by-volume basis or a block-by-block basis. The computer in the source storage device executes: an accepting procedure of accepting transmission file information for identifying a file that is to be a transmission target among a plurality of files stored in a source recording medium; and a storage procedure of storing the transmission file information accepted by the accepting procedure into the source recording medium.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a configuration diagram of a storage system according to this embodiment.

FIG. 2 is a configuration diagram of a first storage device.

FIG. 3 schematically illustrates a plurality of logical volumes that are set on a disk medium.

FIG. 4 illustrates a transmission file management table.

FIG. 5 is a configuration diagram of a second storage device.

FIG. 6 schematically illustrates a plurality of logical volumes that are set on a disk medium.

FIG. 7 illustrates a deletion file management table.

FIG. 8 illustrates a flow of a transmission file accepting process.

FIG. 9 illustrates a flow of a receipt notification process.

FIG. 10 illustrates a flow of a deletion file accepting process.

FIG. 11 illustrates a flow of a file deletion process.

### DESCRIPTION OF EMBODIMENT

Hereinbelow, an embodiment of a storage system will be described with reference to the appended drawings.

<<Configuration>>

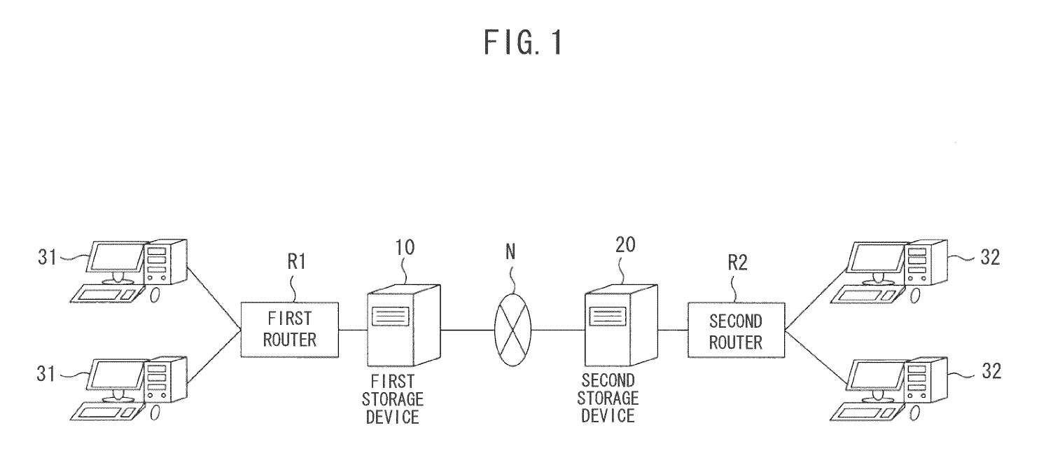

FIG. 1 is a configuration diagram of a storage system according to this embodiment.

As illustrated in FIG. 1, the storage system according to the embodiment comprises a first storage device 10 and a second storage device 20. The first and second storage devices 10 and 20 are connected communicatively with each other via a network N.

The first storage device 10 is connected to at least one first computer 31 via a first router R1, and the second storage device 20 is connected to at least one second computer 32 via a second router R2.

<First Storage Device>

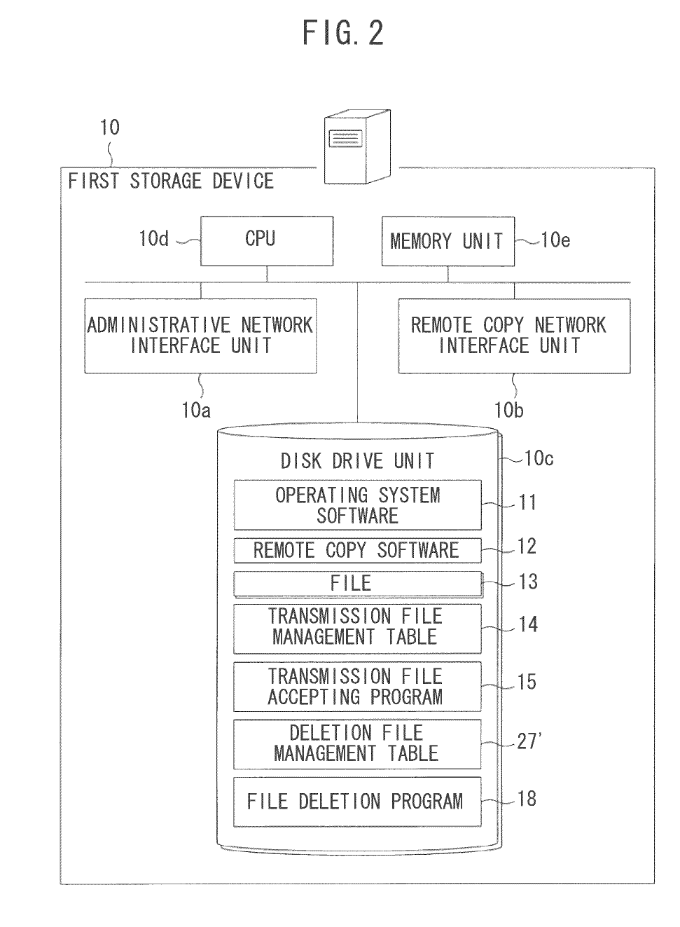

FIG. 2 is a configuration diagram of the first storage device 10.

As illustrated in FIG. 2, the first storage device 10 comprises an administrative network interface unit 10a, a remote copy network interface unit 10b, a disk drive unit 10c, a CPU (Central Process Unit) 10d, and a memory unit 10e.

The administrative network interface unit 10a is a unit for performing data exchange between the first storage device 10 and the first router R1. The remote copy network interface unit 10b is a unit for performing data exchange between the first storage device 10 and a relaying device, not illustrated, on the network N.

The disk drive unit 10c is a unit for recording various programs and various data in a disk medium in such a manner that they can be written and read freely. Examples of such a disk drive unit 10c include a hard disk drive device, a DVD (Digital Versatile Disk) drive device, a DVD+R/RW drive device, and a BD (Blu-ray Disk) drive device. Examples of the disk medium include hard disk, DVD (including DVD-R [Recordable], DVD-RW [Rewritable], DVD-ROM [Read Only Memory], and DVD-RAM [Random Access Memory]), DVD+R/RW, and BD (including BD-R, BD-RE [Rewritable], and BD-ROM).

The CPU 10d is a unit for performing a process according to a program in the disk drive unit 10c. The memory unit 10e is a unit for allowing the CPU 10d to cache programs or data and to deploy workspace.

The first storage device 10 stores operating system software 11 in the disk medium of the disk drive unit 10c.

The operating system software 11 is software for performing provision of API (Application Programming Interface) and ABI (Application Binary Interface) to various applications, management of storage areas in the disk drive unit 10c and the memory unit 10e, management of processes and tasks, provision of utilities such as file management, various setting tools, and editors to applications, and assignment of windows to a plurality of tasks for providing multiple screen outputs. Although not illustrated in the drawings, the operating system software 11 contains a communication interface program. The communication interface program, not illustrated, is a program for performing data exchange with a communication interface program of another computer connected via the network interface units 10a and 10b. An example of this communication interface program is a TCP/IP (Transmission Control Protocol/Internet Protocol) stack.

In this embodiment, the file management function (file system) within the operating system software 11 has seven logical volumes on the disk medium of the disk drive unit 10c, and each of the logical volumes records programs or data on a file-by-file basis. The operating system software 11 is stored in one of the logical volumes.

The first storage device 10 stores remote copy software 12 in the same logical volume that stores the operating system software 11.

The remote copy software 12 is software for periodically reading out data from a copy target and transmits the data to the second storage device 20. The copy target is designated, among the seven logical volumes provided on the disk medium of the disk drive unit 10c, as a predetermined number of logical volumes (or physical blocks in the predetermined number of logical volumes that have been updated within a predetermined period). The remote copy software 12 is also software for receiving data that remote copy software 22 (described later) of the second storage device 20 has transmitted and updating a logical volume of the disk medium within the disk drive unit 10c that corresponds to a logical volume of the remote source by the received data.

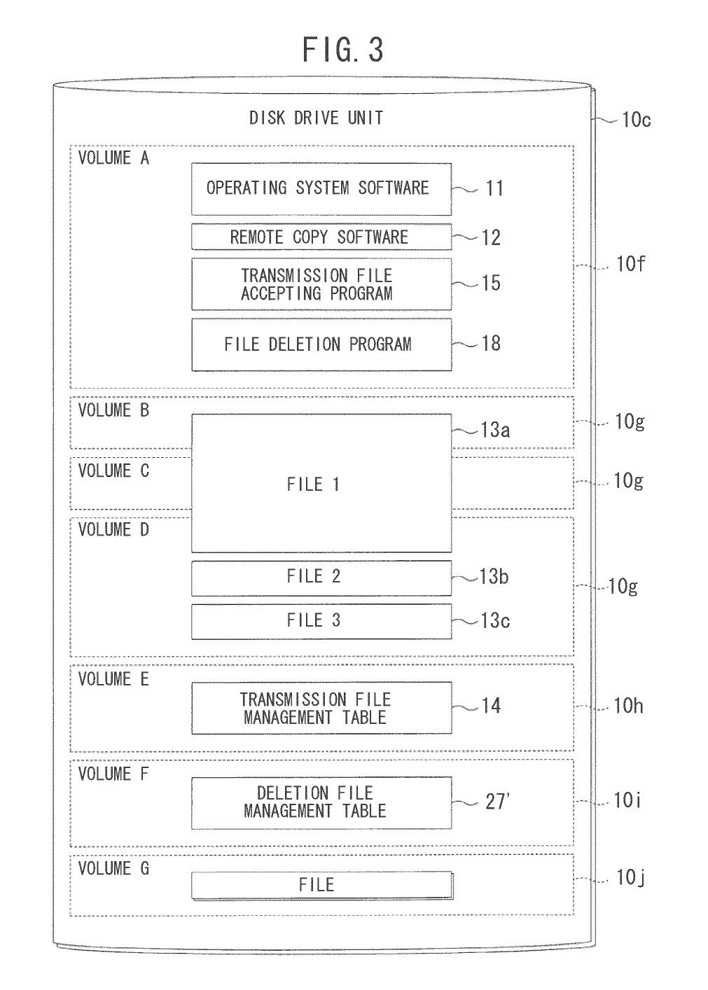

A plurality of logical volumes that are set on the disk medium of the disk drive unit 10c are classified into five types, as illustrated in the schematic view of FIG. 3. A first type logical volume 10f is a logical volume for storing the operating system software 11 and the remote copy software 12. Both second and third type logical volumes 10g and 10h are logical volumes for storing the target that is to be remote-copied by the remote copy software 12 to the second storage device 20. Of these, the second type logical volume 10g stores ordinary files 13a to 13c (13 in FIG. 2) that are the target of remote copy, and the third type logical volume 10h stores a transmission file management table 14 as a file. The transmission file management table 14 records transmission file information for identifying a file that is selected as a transmission file among the files 13a to 13c in the second type logical volume 10g that are designated as the target of the remote copy to the second storage device 20. Thus, the third type logical volume 10h is a logical volume that is utilized for remote-copying the transmission file information. A fourth type logical volume 10i is a logical volume for storing files that are remote-copied from the second storage device 20. In this embodiment, the fourth type logical volume 10i stores a deletion file management table 27′ as a copy of a deletion file management table 27 within the second storage device 20. This deletion file management table 27 will be described later. A fifth type logical volume 10j is a logical volume for storing files that are not remote-copied by the remote copy software 12.

In this embodiment, the transmission file management table 14 for recording the transmission file information is stored in a separate logical volume from the logical volumes that store the files 13 that are the target of remote copy, as illustrated in FIG. 3. However, the invention is not limited to be implemented in this way. For example, the third type logical volume 10h may not be provided, and the transmission file management table 14 may be stored in the second logical volume 10g.

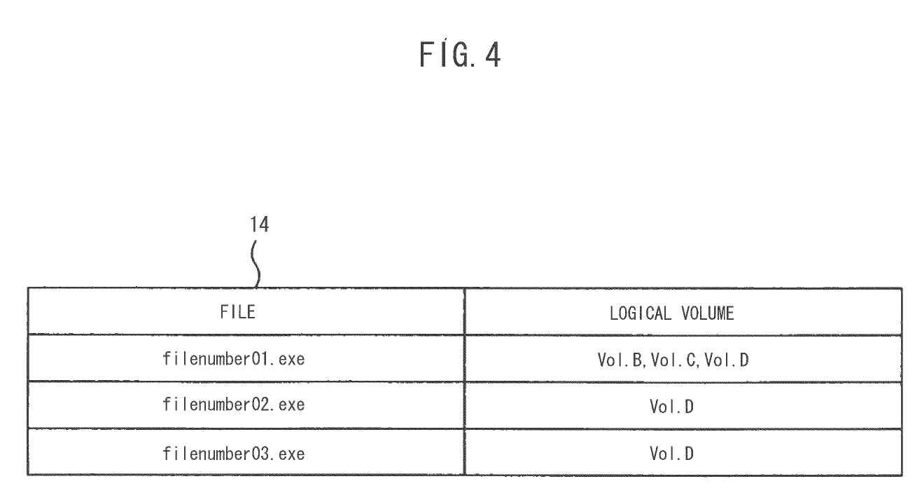

FIG. 4 is a view schematically illustrating the transmission file management table 14.

As illustrated in FIG. 4, the transmission file management table 14 has the same number of records as the number of the transmission files. Each of the records has a “file” field and a “logical volume” field. The “file” field is a field for recording the name of the file. The “logical volume” field is a field for recording the name of the logical volume that stores the just-mentioned file. Accordingly, the above-described transmission file information contains a file name and a logical volume name. It can be noted that when one file is recorded over a plurality of logical volumes (for example, the “file 1” 13a in FIG. 3), a plurality of names of logical volumes are recorded in the “logical volume” field.

As illustrated in FIGS. 2 and 3, the first storage device 10 further stores a transmission file accepting program 15 and a file deletion program 18 in the first type logical volume 10f of the disk medium of the disk drive unit 10c.

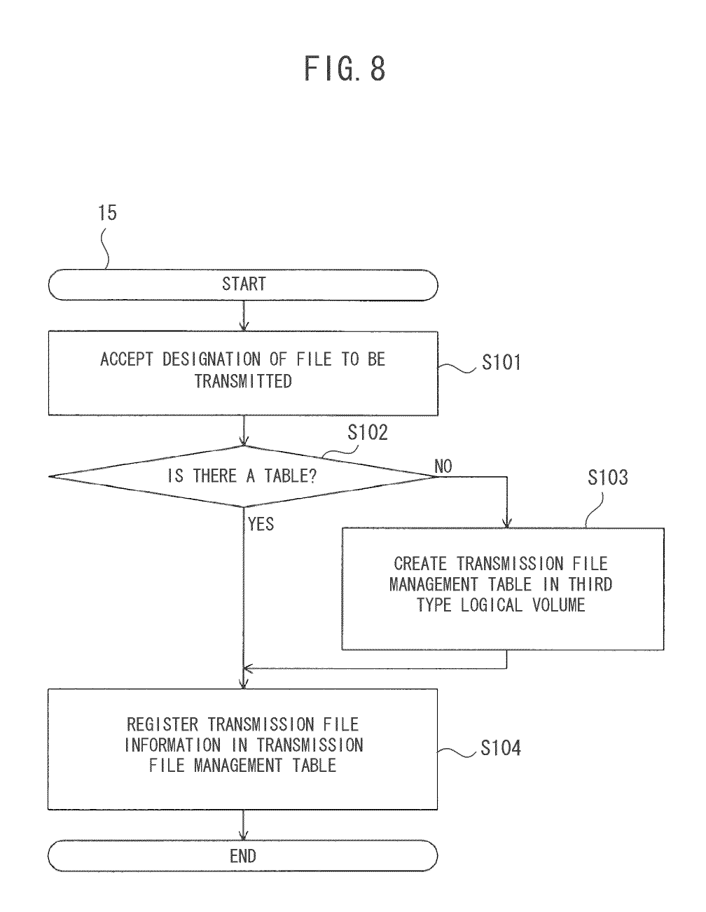

The transmission file accepting program 15 is a program for accepting designation of a file that is to be a transmission target to the second storage device 20, through the first computer 31 from the administrator of the first storage device 10. The details of the transmission file accepting process executed by the CPU 10d according to the transmission file accepting program 15 will be described later with reference to FIG. 8.

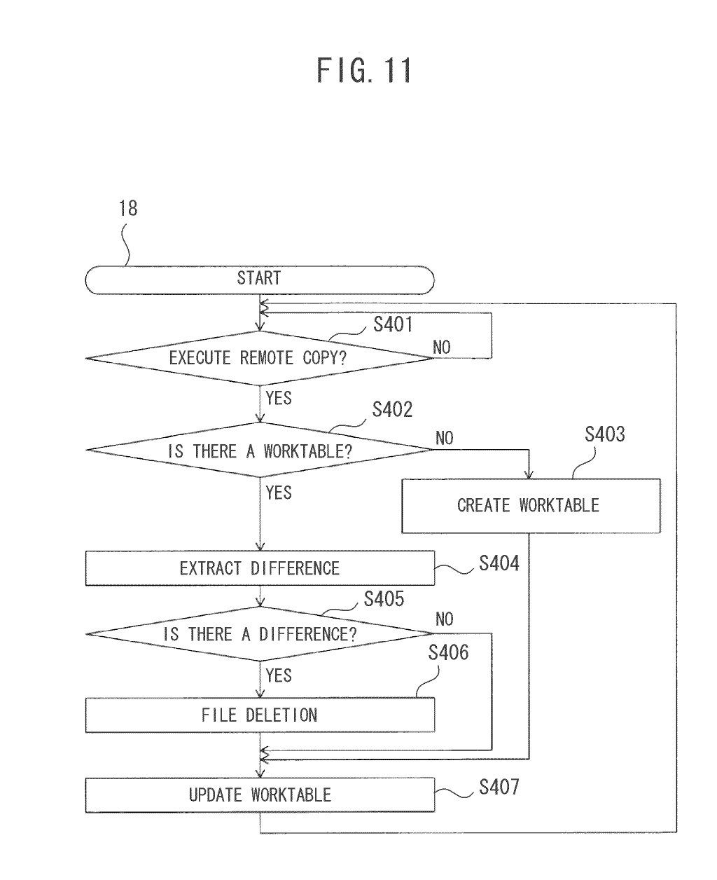

The file deletion program 18 is a program for deleting a file or files from the second type logical volume 10g based on the later-described deletion file management table 27′ that is remote-copied from the second storage device 20. The details of the file deletion process executed by the CPU 10d according to the file deletion program 18 will be described later with reference to FIG. 11.

<Second Storage Device>

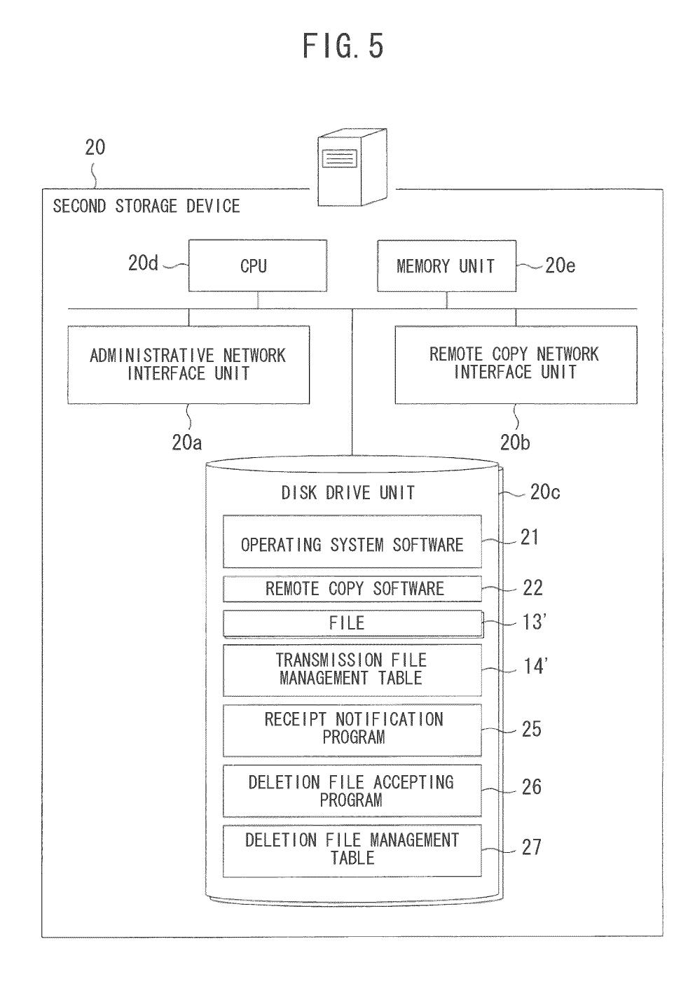

FIG. 5 is a configuration diagram of the second storage device 20.

As illustrated in FIG. 5, the second storage device 20, like the first storage device 10, comprises an administrative network interface unit 20a, a remote copy network interface unit 20b, a disk drive unit 20c, a CPU 20d, and a memory unit 20e.

The administrative network interface unit 20a is a unit for performing data exchange between the second storage device 20 and the second router R2. The remote copy network interface unit 20b is a unit for performing data exchange between the second storage device 20 and a relaying device, not illustrated, on the network N.

The disk drive unit 20c, the CPU 20d, and the memory unit 20e exhibit substantially the same functions as those of the first storage device 10.

The second storage device 20, like the first storage device 10, stores operating system software 21 in the disk medium of the disk drive unit 20c. This operating system software 21 exhibits substantially the same function as that of the first storage device 10. The file management function (file system) within the operating system software 21 has at least five logical volumes on the disk medium of the disk drive unit 20c, and each of the logical volumes records programs or data on a file-by-file basis. The operating system software 21 is stored in one of the logical volumes.

The second storage device 20 stores remote copy software 22 in the same logical volume that stores the operating system software 21.

The remote copy software 22 is software for receiving data that the remote copy software 12 of the first storage device 10 reads and transmits from the above-described copy target, and for updating a corresponding logical volume or physical block of the disk medium within the disk drive unit 20c by the received data. Thus, in the first and second storage devices 10 and 20, the respective remote copy software 12 and 22 cooperate with each other to execute remote copy periodically.

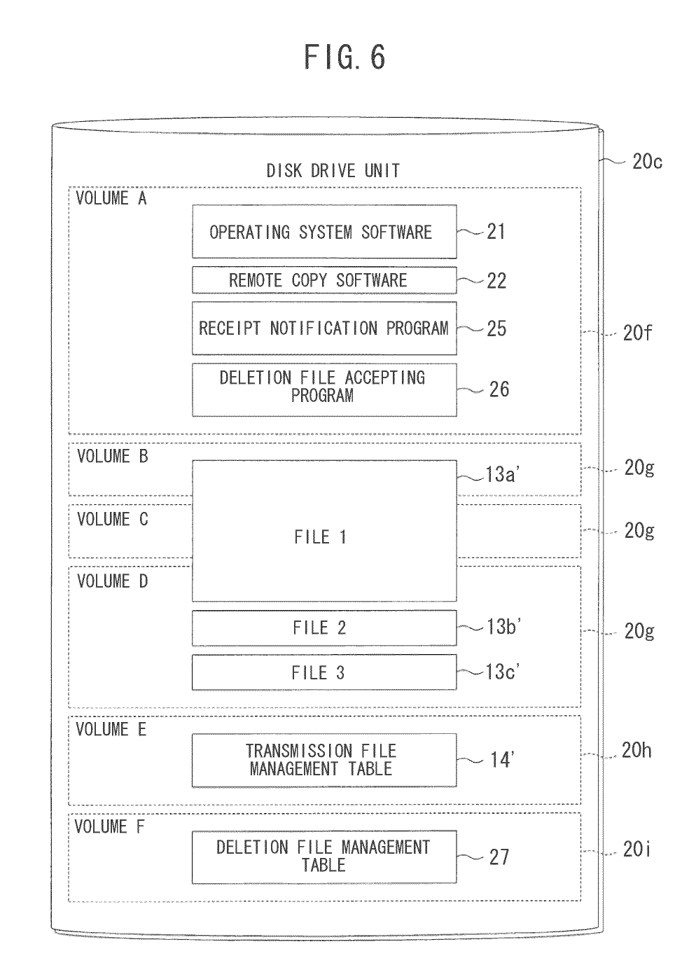

In this remote copy software 22, as well as in the remote copy software 12 of the first storage device 10, logical volumes for storing the items to be remote-copied are defined in advance. Specifically, as illustrated in FIG. 6, logical volumes having the same volume names as those of the second through fourth type logical volumes 10g to 10i on the disk medium of the disk drive unit 10c of the first storage device 10 are provided on the disk medium of the disk drive unit 20c of the second storage device 20. Those logical volumes function as second through fourth type logical volumes 20g to 20i, respectively. Thus, a first type logical volume 20f stores the operating system software 21 and the remote copy software 22. The second type logical volume 20g stores ordinary files 13a′ to 13c′ (13′ in FIG. 5) that are remote-copied from the first storage device 10. The third type logical volume 20h stores a transmission file management table 14′ that is remote-copied from the first storage device 10 as a file. The fourth type logical volume 20i stores the later-described deletion file management table 27 that is to be remote-copied to the first storage device 10.

As illustrated in FIGS. 5 and 6, the second storage device 20 further stores a receipt notification program 25 and a deletion file accepting program 26 in the first type logical volume 20f of the disk medium of the disk drive unit 20c.

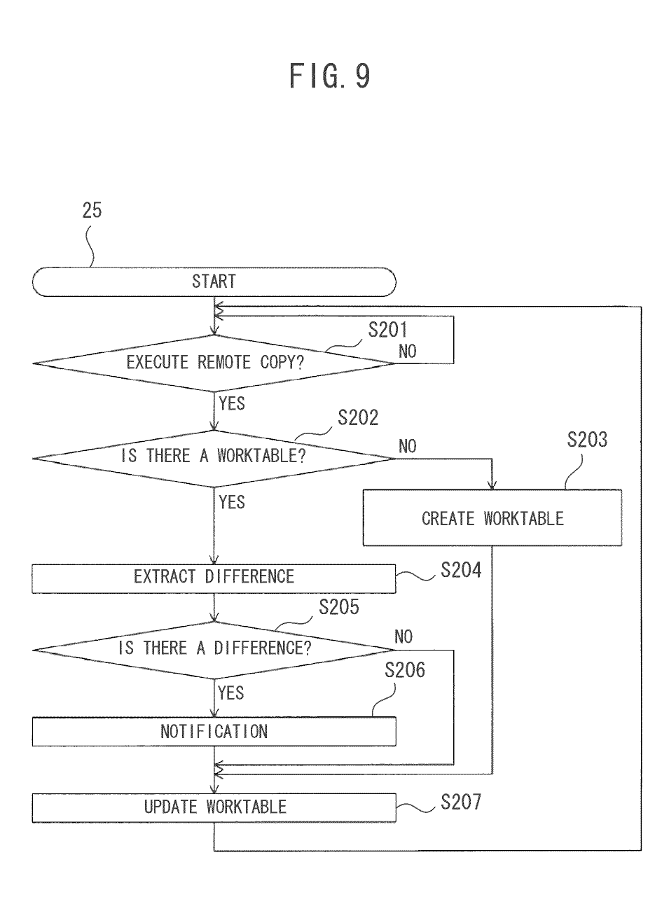

The receipt notification program 25 is a program for notifying reception of the file if a file that is designated as a transmission target by the administrator of the first storage device 10 is contained in the files that are periodically copied from the first storage device 10 by the remote copy function. The details of the receipt notification process executed by the CPU 20d according to the receipt notification program 25 will be described with reference to FIG. 9.

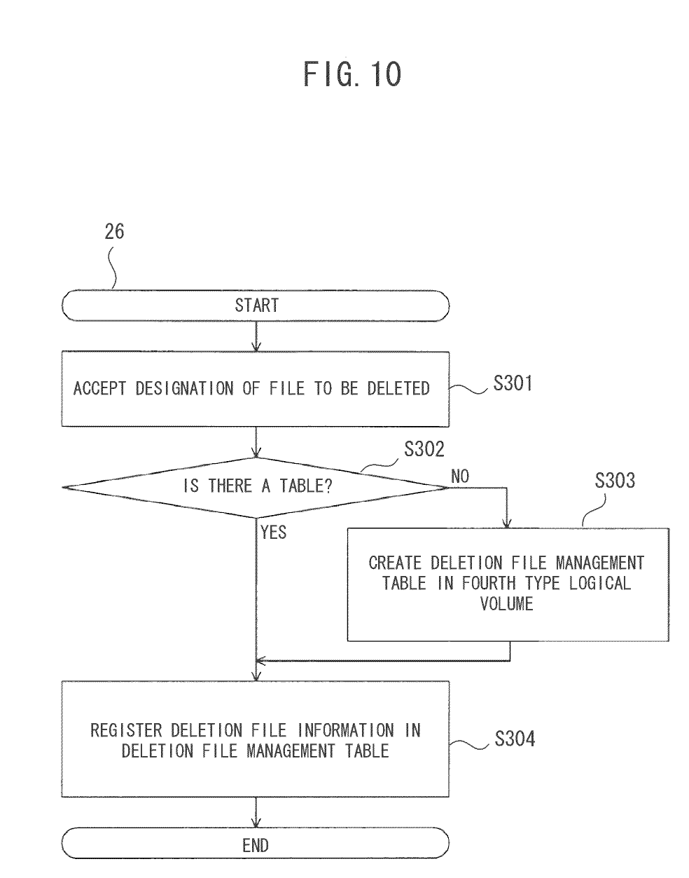

The deletion file accepting program 26 is a program for accepting designation of deletion file information from the administrator of the second storage device 20 through the second computer 32. The deletion file information identifies a file to be deleted from the second type logical volume 20g of the first storage device 10 among the files identified by the transmission file information in the transmission file management table 14′. The details of the deletion file accepting process executed by the CPU 20d according to the deletion file accepting program 26 will be described later with reference to FIG. 10.

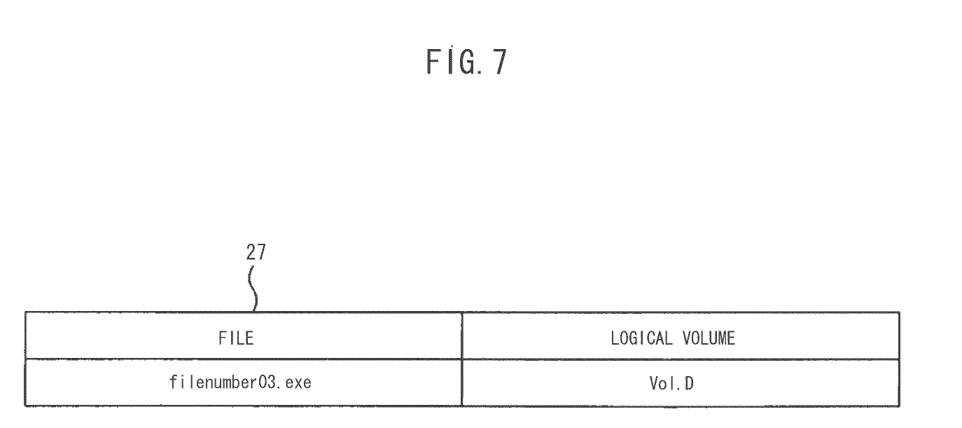

FIG. 7 is a view schematically illustrating the deletion file management table 27.

As illustrated in FIG. 7, the deletion file management table 27 has the same number of records as the number of the files to be deleted. Each of the records has a “file” field and a “logical volume” field. The “file” field is a field for recording the name of the file. The “logical volume” field is a field for recording the name of the logical volume that stores the just-mentioned file. Accordingly, the above-described deletion file information contains a file name and a logical volume name. Like the transmission file management table 14, when one file is recorded over a plurality of logical volumes (for example, the “file 1” 13a′ in FIG. 6), a plurality of names of logical volumes are recorded in the “logical volume” field.

<<Processes>>

<Transmission File Accepting>

The first storage device 10 is configured so that the CPU 10d reads out and starts up the transmission file accepting program 15 to start the transmission file accepting process when the administrator instructs the first storage device 10 to start up the transmission file accepting program 15 through the first computer 31.

FIG. 8 is a chart illustrating the flow of the transmission file accepting process.

After starting the transmission file accepting process, in the first step S101, the CPU 10d accepts designation of a file that is a transmission target from the user of the first computer 31. Specifically, the CPU 10d allows the first computer 31 to display the list of the logical volume names and the file names and of the files stored in the second type logical volumes 10g (for example, as a web page), and accepts a file selected from the list by the administrator as a transmission target.

It can be noted that the transmission file accepting process may be started when the administrator stores a file in the second type logical volumes 10g through the first computer 31. In this case, in step S101, the CPU 10d asks the administrator whether or not a file is to be designated as a transmission target after storing the file through the first computer 31 (for example, through an inquiry screen), and if the administrator designates the file as a transmission target, it accepts the stored file as the transmission target.

It can be noted that this step S101 corresponds to the previously mentioned accepting procedure.

In the next step S102, the CPU 10d determines whether or not the transmission file management table 14 is stored in the third type logical volume 10h. If the transmission file management table 14 is stored in the third type logical volume 10h, the CPU 10d allows the process to proceed to step S104. On the other hand, if the transmission file management table 14 is not stored in the third type logical volume 10h, the CPU 10d allows the process to branch from step S102 to step S103.

In step S103, the CPU 10d creates the transmission file management table 14 newly in the third type logical volume 10h. The transmission file management table 14 created here contains no record (i.e., no transmission file information). After creating the transmission file management table 14, the CPU 10d allows the process to proceed to step S104.

In step S104, the CPU 10d adds the transmission file information that identifies the file accepted as the transmission target in step S101 to the transmission file management table 14 within the third type logical volume 10h. Thereafter, the CPU 10d ends the transmission file accepting process pertaining to FIG. 8.

It can be noted that steps S102 through S104 correspond to the previously mentioned storage procedure.

According to this transmission file accepting process, the administrator of the first storage device 10 can designate a file to be explicitly specified as a transmission target for the administrator of the second storage device 20, among the files stored in the second type logical volume 10g as the target to be copied to the second storage device 20 by the remote copy.

In other words, the administrator of the first storage device 10 can mix the file to be transmitted to the second storage device 20 and the transmission file information for identifying the transmission file into the target to be copied to the second storage device 20 periodically by the remote copy function (i.e. into the files in the second and third type logical volumes 10g and 10h).

### <Receipt Notification>

The second storage device 20 is configured so that, after the main power is turned on, the CPU 20d reads out and starts up the receipt notification program 25 to start a receipt notification process.

FIG. 9 is a chart illustrating the flow of the receipt notification process.

After starting the receipt notification process, in the first step S201, the CPU 20d stands by until the remote copy from the first storage device 10 to the second storage device 20 is performed one time.

If the internal spaces of the second and third type logical volumes 20g and 20h are updated by performing the remote copy one time, the CPU 20d allows the process to proceed to step S202.

In step S202, the CPU 20d determines whether or not a work table exists on the memory unit 20e. The work table is for saving the contents of the transmission file management table 14′ that has been stored in the third type logical volume 20h at the most recent remote copy among a plurality of copies. If no work table exists on the memory unit 20e, the CPU 20d allows the process to branch from step S202 to step S203.

In step S203, the CPU 20d creates a work table newly on the memory unit 20e. The work table created here contains no record. After creating the work table, the CPU 20d allows the process to proceed to step S207.

On the other hand, in step S202, if a work table exists on the memory unit 20e, the CPU 20d allows the process to proceed to step S204.

In step S204, the CPU 20d extracts a difference between the work table on the memory unit 20e and the transmission file management table 14′ in the third type logical volume 20h.

In the next step S205, the CPU 20d determines whether or not a difference exists based on the result of the difference extraction in step S204. If no difference exists, the CPU 20d allows the process to branch from step S205 to step S207. On the other hand, if a difference exists, the CPU 20d allows the process to proceed to step S206.

It can be noted that steps S201, S202, S204, and S205 correspond to the determining procedure.

In step S206, the CPU 20d notifies the administrator of the second storage device 20 of receipt of the file identified by the transmission file information extracted as the difference, through the second computer 32. Examples of the notification method include a method of displaying the name of the transmission file and the logical volume name on a screen in the form of a web page at the second computer 32, and a method of transmitting an electronic mail containing the file name and the logical volume name to the second computer 32. Upon notifying the administrator of the second storage device 20 of the receipt of the file, the CPU 20d allows the process to Proceed to step S207.

It can be noted that step S206 corresponds to the notification procedure.

In step S207, the CPU 20d updates the contents of the work table on the memory unit 20e by the contents of the transmission file management table 14′ in the third type logical volume 20h at that time point. Thereafter, the CPU 20d allows the process to return to step S201 and stands by until the next remote copy is performed.

It can be noted that steps S203 and S207 correspond to the updating procedure.

According to this receipt notification process, in the case that remote copy is performed after the administrator of the first storage device 10 has designated a transmission file and thereby the transmission file information has been stored into the transmission file management table 14, the transmission file management table 14′ remote-copied from the first storage device 10 is compared to the previous transmission file management table 14′ to extract a difference. If there is a difference (i.e., if the transmission file information has increased), the administrator of the second storage device 20 is notified that there is a difference. As a result, the administrator of the second storage device 20 can retrieve, from the second type logical volume 20h, the file that the administrator of the first storage device 10 has intended to transmit, based on the file name and logical volume name contained in the notification.

<Deletion File Accepting>

The second storage device 20 is configured so that the CPU 20d reads out and starts up the deletion file accepting program 26 to start the deletion file accepting process when the administrator of the second storage device 20 instructs the second storage device 20 to start up the deletion file accepting program 26 through the second computer 32.

FIG. 10 is a chart illustrating the flow of the deletion file accepting process.

After starting the deletion file accepting process, in the first step S301, the CPU 20d allows the second computer 32 to display a list of file names and logical volume names based on the transmission file management table 14′ in the third type logical volume 20h (for example, as a web page), and accepts a file that is selected by the administrator from the list as a deletion target.

It can be noted that step S301 corresponds to the second accepting procedure.

In the next step S302, the CPU 20d determines whether or not the deletion file management table 27 is stored in the fourth type logical volume 20i. Then, if the deletion file management table 27 is stored in the fourth type logical volume 20i, the CPU 20d allows the process to proceed to step S304. On the other hand, if the deletion file management table 27 is not stored in the fourth type logical volume 20i, the CPU 20d allows the process to branch from step S302 to step S303.

In step S303, the CPU 20d creates the deletion file management table 27 newly in the fourth type logical volume 20i. The deletion file management table 27 created here contains no record (i.e., no deletion file information). After creating the deletion file management table 27, the CPU 20d allows the process to proceed to step S304.

In step S304, the CPU 20d adds the deletion file information that identifies the file accepted as the deletion target in step S301 to the deletion file management table 27 within the fourth type logical volume 20i. Thereafter, the CPU 20d ends the deletion file accepting process pertaining to FIG. 10.

It can be understood that steps S302 through S304 correspond to the second storage procedure.

According to this deletion file accepting process, the administrator of the second storage device 20 receives notification of receipt and retrieves a file among the files 13′ remote-copied from the first storage device 10 to the second storage device 20. Thereby, the administrator of the second storage device 20 can designate the just-mentioned file as a deletion target when the file needs to be deleted from the first and second storage devices 20.

<Deletion>

The first storage device 10 is configured so that, after the main power is turned on, the CPU 10d reads out and starts up the file deletion program 18 to start a file deletion process.

FIG. 11 is a chart illustrating the flow of the file deletion process.

After starting the file deletion process, in the first step S401, the CPU 10d stands by until the remote copy from the first storage device 10 to the second storage device 20 is performed one time. If the internal space of the fourth type logical volumes 10i is updated by performing the remote copy one time, the CPU 10d allows the process to proceed to step S402.

The remote copy software 12 and 22 for performing remote copy from the second storage device 20 to the first storage device 10 correspond to the retrieval procedure.

In step S402, the CPU 10d determines whether or not a work table exists on the memory unit 10e. The work table is for saving the contents of the deletion file management table 27′ that has been stored in the fourth type logical volume 10i as the most recent remote copy among a plurality of times of remote copying that is performed periodically. If no worktable exists in the memory unit 10e, the CPU 10d allows the process to branch from step S402 to step S403.

In step S403, the CPU 10d creates a new work table on the memory unit 10e. The work table created here contains no record. After creating the work table, the CPU 10d allows the process to proceed to step S407.

On the other hand, in step S402, if a work table exists on the memory unit 10e, the CPU 10d allows the process to proceed to step S404.

In step S404, the CPU 10d extracts a difference between the work table on the memory unit 10e and the deletion file management table 27′ in the fourth type logical volume 10i.

In the next step S405, the CPU 10d determines whether or not a difference exists based on the result of the difference extraction in step S404. If no difference exists, the CPU 10d allows the process to branch from step S405 to step S407. On the other hand, if a difference exists, the CPU 10d allows the process to proceed to step S406.

In step S406, the CPU 10d deletes the file identified by the deletion file information extracted as the difference from the second type logical volume 10g. Thereafter, the CPU 10d allows the process to proceed to step S407.

In step S407, the CPU 10d updates the contents of the work table on the memory unit 10e by the contents of the deletion file management table 27′ in the fourth type logical volume 10i at that time point. Thereafter, the CPU 10d allows the process to return to step S401 and stands by until the next remote copy is performed.

Steps S402 through S407 correspond to the deletion procedure.

According to this file deletion process, if remote copy is performed after the administrator of the second storage device 20 designates a file to be deleted and thereby the deletion file information has been stored into the deletion file management table 27, the deletion file management table 27′ remote-copied from the first storage device 20 is compared to the previous transmission file management table 27′ to extract a difference. If there is a difference (i.e., if the deletion file information has increased), the file is deleted from the second type logical volume 10g of the first storage device 10. Thereafter, when remote copy from the first storage device 10 to the second storage device 20 is executed, the file that has been transmitted from the administrator of the first storage device 10 to the administrator of the second storage device 20 is completely deleted from the first and second storage devices 10 and 20.

<<Advantages>>

The administrator of the first storage device 10 stores the file to be transmitted to the administrator of the second storage device 20 into the second type logical volume 10g of the first storage device 10 through the first computer 31. At the same time, the administrator of the first storage device 10 stores the transmission file information that identifies the just-mentioned file into the transmission file management table 14 through the transmission file accepting process pertaining to FIG. 8.

Then, the just-mentioned file and the transmission file information are copied to the second storage device 20 by the remote copy function (the remote copy software 12 and 22) of the first and second storage devices 10 and 20. The second storage device 20 notifies the administrator of reception of the file through the receipt notification process pertaining to FIG. 9 and the second computer 32.

Based on the notification, the administrator of the second storage device 20 can identify and retrieve the file that the administrator of the first storage device 10 has intended to transmit among the files remote-copied from the first storage device.

Thus, this embodiment makes it possible to use a storage system that implements the conventional remote copy function also as a file transmission system.

In addition, the administrator of the second storage device 20 selects a file to be deleted from the first and second storage devices 10 and 20 among the files received from the administrator of the first storage device 10 as the transmission target through the deletion file accepting process of FIG. 10 and the second computer 32. The administrator stores the deletion file information for identifying the selected file into the deletion file management table 27.

Then, the deletion file information is copied to the first storage device 10 by the remote copy function (the remote copy software 12 and 22) of the first and second storage devices 10 and 20. The first storage device 10 deletes the file identified by the deletion file information from the second type logical volume 10g through the file deletion process of FIG. 11. Then, when the subsequent remote copy is performed, the file that the administrator of the second storage device 20 has intended to delete is completely deleted from the first and second storage devices 10 and 20.

Thus, according to this embodiment, the administrator of the second storage device 20 need not leave the files received from the administrator of the first storage device 10 in the first and second storage devices 10 and 20. Therefore, the storage capacity is not wasted.

<Explanation about Unit>

In the embodiment described above, all the units 10a to 10e and 20a to 20e within the first and second storage devices 10 and 20 may comprise combinations of software elements and hardware elements or may comprise hardware elements alone.

Examples of the software elements include interface programs, driver programs, tables, data, and combinations thereof. These may be ones stored in a later-described computer-readable medium or may be firmware incorporated fixedly in a memory device such as a ROM (Read Only Memory) and an LSI (Large Scale Integration).

Examples of the hardware elements include FPGA (Field Programmable Gate Array), ASIC (Application Specific Integrated Circuit), gate arrays, combinations of logic gates, signal process circuits, analog circuits, and other circuits. Of these, the logic gate may comprise AND, OR, NOT, NAND, NOR, a flip-flop, and a counter circuit. The signal process circuit may comprise a circuit element for executing an operation of signal values such as addition, multiplication, division, inversion, summing, differentiation, and integration. The analog circuit may comprise a circuit element for executing an operation such as amplification, addition, multiplication, differentiation, and integration.

It can be noted that the elements that constitute the respective units 10a to 10e and 20a to 20e in the first and second storage devices 10 and 20 are not limited to, but may be other elements equivalent to, those exemplified in the foregoing.

<Explanation about Software and Program>

In the embodiment described above, the software 11, 12, 21, 22, the tables 14, 14′, 27, 27′, the programs 15, 18, 25, 26, as well as the above-described software elements in the first and second storage devices 10 and 20 may comprise any of the elements such as a software component, a component made with a procedural language, an object-oriented software component, a class component, a component managed as a task, a component managed as a process, a function, an attribute, a procedure, a subroutine (software routine), a segment or a portion of a program code, a driver, firmware, a microcode, a code, a code segment, an extra segment, a stack segment, a program area, a data area, data, database, a data structure, a field, a record, a table, a matrix table, an array, a variable, and a parameter.

The software 11, 12, 21, 22, the tables 14, 14′, 27, 27′ and the programs 15, 18, 25, 26, as well as the above-described software elements in the first and second storage devices 10 and 20 may be described by any of the C language, C++, Java (trademark of Sun Microsystems, Inc. of the U.S.), Visual Basic (trademark of Microsoft Corp. of the U.S.) Perl, Ruby, and many other programming languages.

The instructions, codes, and data contained in the software 11, 12, 21, 22, the tables 14, 14′, 27, 27′, and the programs 15, 18, 25, 26, as well as the above-described software elements in the first and second storage devices 10 and 20 may be transmitted to or loaded into a computer or a computer that is incorporated in a machine or equipment via a wired network card and a wired network or via wireless card and a wireless network.

In the just-mentioned transmission or loading, data signal is incorporated in, for example, a carrier wave so that it travels over a wired network or a wireless network. However, the data signal may be transferred as what is called baseband signal, not as the just-mentioned carrier wave. Such a carrier wave may be transmitted in electric, magnetic, electromagnetic, optical, acoustic or other form.

Herein, the wired network and the wireless network may be, for example, telephone line, network line, cable (including optical cable and metallic cable), wireless link, mobile telephone access line, PHS (Personal Handyphone System) network, wireless LAN (Local Area Network), Bluetooth (a trademark of Bluetooth Special Interest Group), on-vehicle type wireless communication (including DSRC [Dedicated Short Range Communication]) and a network made of any of them. The data signal transfers information containing instructions, codes, and data to a node or an element on the network.

It can be noted that the software 11, 12, 21, 22, the tables 14, 14′, 27, 27′, and the programs 15, 18, 25, 26, as well as the elements that constitute the above-described software elements in the first and second storage devices 10 and 20 are not limited to, but may be other elements equivalent to, those exemplified in the foregoing.

<Explanation about Computer-Readable Media>

Any of the functions in the embodiment described above may be coded and stored in a storage area of a computer-readable medium. In this case, a program for implementing the function may be provided to a computer or a computer incorporated in a machine or equipment via the computer-readable medium. The computer, or the computer incorporated in a machine or equipment may implement the function by reading out the program from the storage area of the computer-readable medium and executing the program.

Herein, the term “computer-readable medium” refers to a recording medium that stores information such as programs and data by an electrical, magnetic, optical, chemical, physical, or mechanical effect and holds the information in a state that can be read by a computer.

An example of the electrical or magnetic effect is writing of data to an element on a ROM (Read Only Memory) that is composed of fuse. An example of the magnetic or physical effect is developing toner to a latent image on a paper medium. The information recorded on the paper medium may be read optically, for example. An example of the optical and chemical effect is thin-film formation on a substrate or embossing of a substrate. The information recorded in embossed form may be read optically, for example. Examples of the chemical effect include an oxidation-reduction reaction on a substrate as well as an oxide film formation, a nitride film formation, and a photoresist development on a semiconductor substrate. Examples of the physical or mechanical effect include embossing of an emboss card and punching of a paper medium.

The computer-readable medium may include one that is mounted removably to a computer, or a computer incorporated in a machine or equipment. Examples of the removable computer-readable medium include DVD (including DVD-R, DVD-RW, DVD-ROM, and DVD-RAM), DVD+R/RW, BD (including BD-R, BD-RE, and BD-ROM), CD (Compact Disk) (including CD-R, CD-RW, and CD-ROM) MO (Magneto Optical) disk, other optical disk media, flexible disks (including Floppy disk [“Floppy” is a trademark of Hitachi, Ltd.]), other magnetic disk media, memory cards (such as Compact Flash [a trademark of SanDisk Corp in the U.S.], SmartMedia [a trademark of Toshiba Corp.], SD cards [trademark of SanDisk Corp of the U.S., Matsushita Electric Industrial Co., Ltd., and Toshiba Corp.], Memory Stick [trademark of Sony Corp.], MMC [trademark of Siemens Corp. in the U.S. and SanDisk Corp in the U.S.]), magnetic tapes, and other tape media, as well as a memory device that incorporates any of them. The memory device may include one that further incorporates DRAM (Dynamic Random Access Memory) or SRAM (Static Random Access Memory).

The computer-readable medium may include one that is mounted fixedly to a computer or to a computer incorporated in a machine or equipment. Examples of this type of the computer-readable medium include harddisk, DRAM, SRAM, ROM, EEPROM (Electronically Erasable and Programmable Read Only Memory), and flash memory.

What is claimed is:

1. A remote copy method executed in a storage system comprising a plurality of storage devices each comprising a recording medium for recording data on a file-by-file basis, and a computer for controlling the recording medium, the plurality of storage devices connected to each other via a network, wherein data within the recording medium contained in a source storage device are remote-copied to the recording medium within a destination storage device on a volume-by-volume basis or a block-by-block basis, the remote copy method comprising:
accepting transmission file information for identifying a file that is to be a transmission target among a plurality of files stored in a source recording medium; and
storing the accepted transmission file information into the source recording medium.

2. The remote copy method according to claim 1, the method further comprising:
determining whether or not there is a difference between the transmission file information in a destination recording medium and the transmission file information stored in a memory device when the destination recording medium is updated by remote copy;
notifying, if it is determined that there is a difference between the transmission file information, a user of receipt of a file identified by the transmission file information relating to the difference; and
updating the transmission file information in the memory device by the transmission file information in the destination recording medium.

3. The remote copy method according to claim 2, the method further comprising:
accepting deletion file information for identifying a file that is to be a deletion target from the source recording medium among the files identified by the transmission file information in the memory device;
recording the accepted deletion file information into the destination recording medium;
retrieving the deletion file information from the destination storage device; and
deleting, among the files stored in the source recording medium, a file identified by the retrieved deletion file information.

4. The remote copy method according to claim 1, wherein the transmission file information comprises a name of a file and a name of a volume in which the file is stored.

5. A storage system comprising a plurality of storage devices for recording data in a recording medium on a file-by-file basis, the storage devices being connected to each other via a network, wherein data within a recording medium contained in a source storage device are remote-copied to a recording medium in a destination storage device on a volume-by-volume basis or a block by block basis, and wherein the source storage device comprises:
an accepting unit for accepting transmission file information for identifying a file that is to be a transmission target among a plurality of files stored in a source recording medium; and
a storage unit for storing the transmission file information accepted by the accepting unit into the source recording medium.

6. The storage system according to claim 5, wherein the computer in the destination storage device comprises:
a determining unit for determining whether or not there is a difference between the transmission file information in a destination recording medium and the transmission file information stored in a memory device when the destination recording medium is updated by remote copy;
a notifying unit for notifying, if the determining unit determines that there is a difference, a user of receipt of a file identified by the transmission file information relating to the difference; and
an updating unit for updating the transmission file information in the memory device by the transmission file information in the destination recording medium.

7. The storage system according to claim 6, wherein the computer in the destination storage device further comprises:
a second accepting unit for accepting deletion file information for identifying a file that is to be a deletion target from the source recording medium among the files identified by the transmission file information in the memory device; and
a second storage unit for recording the deletion file information accepted by the second accepting unit in the destination recording medium, and wherein
the computer in the source storage device further comprises:
a retrieval unit for retrieving the deletion file information from the destination storage device; and
a deletion unit for deleting, among the files stored in the source recording medium, a file identified by the deletion file information retrieved by the retrieval unit.

8. The storage system according to claim 5, wherein the transmission file information comprises a name of a file and a name of a volume in which the file is stored.
